(19) United States
(12) Patent Application Publication
(10) Pub. No.: US 2019/0234805 A1
(43) Pub. Date: Aug. 1, 2019

(54) WIRELESSLY COMMUNICATING BEVERAGE PROBE

(71) Applicant: Blue Quench LLC, Miramar Beach, FL (US)

(72) Inventor: John Lauchnor, Miramar Beach, FL (US)

(21) Appl. No.: 16/380,768

(22) Filed: Apr. 10, 2019

Related U.S. Application Data
(63) Continuation of application No. PCT/US2018/064956, filed on Dec. 11, 2018.
(60) Provisional application No. 62/597,152, filed on Dec. 11, 2017.
(60) Provisional application No. 62/679,017, filed on May 31, 2018.

(51) Int. Cl. G01K 1/14; G01K 1/02; B67B 7/04

(52) U.S. Cl. CPC G01K 1/14; G01K 1/024; B67B 2007/0488; G01K 2207/02; B67B 7/04

(57) ABSTRACT

A disclosed bottle opener includes a probe and a temperature sensor circuit coupled to the probe. The temperature sensor circuit is configured to measure a temperature of contents of a bottle. The bottle opener includes a corkscrew coupled to the body and configured to remove a stopper from the bottle. The bottle opener includes a communication circuit configured and arranged to wirelessly communicate with an external electronic device. The bottle opener includes a power circuit configured and arranged to supply power to the communication circuit, and the temperature sensor circuit.

### CROSS-REFERENCE TO RELATED APPLICATIONS

The present patent application is a continuation of and claims the benefit of priority to International Patent Application No. PCT/US18/64956, filed Dec. 11, 2018, which in turn claims the benefit of priority to U.S. Provisional Patent Application Ser. No. 62/597,152, filed December 11, 2017, and U.S. Provisional Patent Application Ser. No. 62/679,017, filed May 31, 2018. Each of the aforementioned patent applications is incorporated by reference herein in its entirety for any purpose whatsoever.

### BACKGROUND

The present disclosure relates to a probe for beverage containers including wireless communication with a separate electronic device and a temperature sensor to determine when beverages have achieved a pre-selected temperature. The probe provides a visual or other notification of when the temperature of the beverage in the container is at, above, or below a particular temperature. The present disclosure also relates to mobile applications and other embodiments for controlling or otherwise utilizing the probe, as well as receiving, recording, and if desired, displaying temperature data received from the probe. The present disclosure also relates to a bottle opener including wireless communication with a separate electronic device and a temperature sensor to determine when beverages have achieved a pre-selected temperature. The bottle opener provides a visual or other notification of when the temperature of the beverage in the bottle is at, above, or below a particular temperature.

### SUMMARY OF THE DISCLOSURE

In general, in a first aspect, the disclosure features embodiments of a probe configured to be received in an opening of a beverage container. The probe includes a first body, such as a housing or a stopper, configured and arranged to fit at least partially through the opening of the beverage container, a communication circuit configured and arranged to wirelessly communicate with an external electronic device, a temperature sensor circuit configured and arranged to measure a temperature (e.g., of the contents, such as liquid, solid, etc.) in the beverage container, and a power circuit configured and arranged to supply power to the communication circuit.

If desired, the probe can further include a display configured and arranged to display the measured temperature. In some embodiments, the device can include a probe with a distal end configured to be pushed through a native stopper disposed in the beverage container. In some other embodiments, the device can include a stopper that is configured and arranged to be received in the opening of the beverage container after a native stopper is removed from the beverage container. The stopper can be configured and arranged to prevent a fluid (e.g., liquid or gas) in the container from flowing through the opening.

The probe can further include a housing in which the display is disposed. The second housing can be rotatably coupled to the first body, stopper, or the like via a bearing. The device can further include a counterweight configured and arranged to maintain a relative stationary orientation of the housing while the housing rotates with respect to the first body or stopper. The communication circuit can be configured and arranged to send a signal to the external electronic device in response to the temperature sensor measuring a predetermined temperature. The communication circuit can be configured and arranged to trigger deactivation of an operation of the external electronic device. The first body or stopper can include a sealing ring that cooperates with an inner surface of the beverage container to prevent the fluid in the beverage container from flowing through the opening. If desired, the probe can further include a lever that engages an articulable seal to prevent the fluid in the beverage container from flowing through the opening. If desired, the first body or stopper can include a taper to make it harder to remove the probe from the bottle. The temperature sensor can be configured to measure the temperature of the fluid by way of direct physical contact, or indirect contact.

The disclosure further provides a beverage cooling system that includes at least one liquid pump, at least one liquid conduit, and at least one quench container that is configured and arranged to be in fluid communication with the liquid pump and the at least one conduit. The at least one quench container can be disposed proximate a reservoir. The at least one quench container can define at least one beverage container space therein for holding and cooling at least one beverage container, wherein activation of the pump causes water to be drawn from the cooled water bath of the reservoir and directed through the at least one conduit into the at least one quench container. The at least one quench container can be further configured and arranged to direct the water from the cooled water bath via the pump over the at least one beverage container in the at least one beverage container space to enhance cooling of a beverage in the at least one beverage container. The system further includes a probe as described herein disposed in an opening of a beverage container.

The system can be configured and arranged to cause the pump to be deactivated in response to the temperature sensor detecting that the temperature of the fluid in the beverage container has reached a predetermined temperature. The system can include at least one drive axle including at least one drive wheel disposed thereon for engaging the beverage container to cause the beverage container to rotate while being cooled with water from the cooled water bath. The system can be configured and arranged to cause a motor coupled to the at least one drive axle to be deactivated in response to the temperature sensor detecting that the temperature of the fluid in the beverage container has reached a predetermined temperature.

In general, in a second aspect, the disclosure features embodiments of a bottle opener. The bottle opener includes a body (e.g., a stopper, housing, or other structure), a temperature sensor circuit coupled to the body and configured to measure a temperature of a fluid (e.g., liquid) in a bottle, a corkscrew coupled to the body and configured to remove a stopper from the bottle, a communication circuit configured and arranged to wirelessly communicate with an external electronic device, and a power circuit configured and arranged to supply power to the communication circuit, and the temperature sensor.

If desired, the probe can further include a display coupled to the power circuit and configured to display the measured temperature. The temperature sensor circuit can be configured to measure the temperature of the fluid while the stopper is in the bottle. The temperature sensor circuit can configured to measure the temperature of the fluid while the corkscrew engages the stopper in the bottle. The temperature sensor circuit and the corkscrew can have a common central axis. The corkscrew can be the temperature sensor. If desired, the corkscrew can be hollow (for example), the temperature sensor can be coupled to an end of the corkscrew, and connections between the temperature sensor circuit and the power circuit can pass through the hollow corkscrew. If desired, the bottle opener can include an extension member rotatably coupled to the body or stopper. If desired, the bottle opener can include a retainer hingedly coupled to the body and configured to receive a neck of the bottle and secure the neck of the bottle. The communication circuit can be configured to send a signal to an external electronic device in response to the temperature sensor circuit measuring a predetermined temperature. The communication circuit can be configured to trigger deactivation of an operation of the external electronic device in response to the temperature sensor measuring the predetermined temperature.

If desired, any probe as set forth herein can be provided with a lock for locking the probe to the beverage container. The lock can be configured and arranged to be adjusted from a first unlocked condition, wherein the lock is disengaged and the probe can be removed from the beverage container, to a second, locked condition, wherein the probe is not removable from the beverage container. The lock can include at least one displaceable arm that can be moved into engagement with a portion of the beverage container. The portion of the beverage container with which the lock engages can include one or more of a radially outwardly extending flange of the beverage container, radially inwardly facing surface of the beverage container, an inner surface of the beverage container, and a bottom of the beverage container. For example, the lock can be configured to engage with a ridge or boss on a bottom of the beverage container, or with an indentation formed on a bottom of the beverage container.

The above advantages and features are of representative embodiments only, and are presented only to assist in understanding the disclosure. It should be understood that these are not to be considered limitations on the disclosure as defined by the claims. Additional features and advantages of embodiments of the disclosure will become apparent in the following description, from the drawings, and from the claims.

### DESCRIPTION OF THE DRAWINGS

Further objects and advantages of the disclosure will become apparent from the following description and from the accompanying drawings, wherein:

FIG. 1A illustrates a cross-sectional view of an illustrative probe in accordance with the present disclosure;

FIG. 1B illustrates a top view of an illustrative probe in accordance with the present disclosure;

FIG. 1C presents an example of a beverage cooler that can be used with the illustrative probe in accordance with the present disclosure;

FIG. 2 illustrates a cross-sectional view of an illustrative probe in accordance with the present disclosure;

FIG. 3 illustrates a cross-sectional view of an illustrative probe in accordance with the present disclosure;

FIG. 4 illustrates a view of a further embodiment of a probe in accordance with the disclosure;

FIG. 5A illustrates a side view of an illustrative bottle opener in accordance with the present disclosure;

FIG. 5B is an enlarged view of a portion of the bottle opener of FIG. 5A;

FIG. 5C illustrates a side view of the bottle opener of FIG. 5A;

FIGS. 5D-5F illustrate a back view, a side view, and a front view of the bottle opener of FIG. 5A, respectively;

FIGS. 5G-5I illustrate isometric views of the bottle opener of FIG. 5A;

FIGS. 6A-6G illustrate aspects of further embodiments in accordance with the disclosure;

FIGS. 7A-7D illustrate aspects of an additional embodiment in accordance with the disclosure; and

FIG. 8 illustrates an illustrative user interface of an external device displaying a measured temperature of a beverage in accordance with the present disclosure.

### DETAILED DESCRIPTION OF THE PREFERRED EMBODIMENTS

For ease of illustration, in the following description the same reference numerals may be used in different diagrams to refer to the same elements or additional instances of the same element.

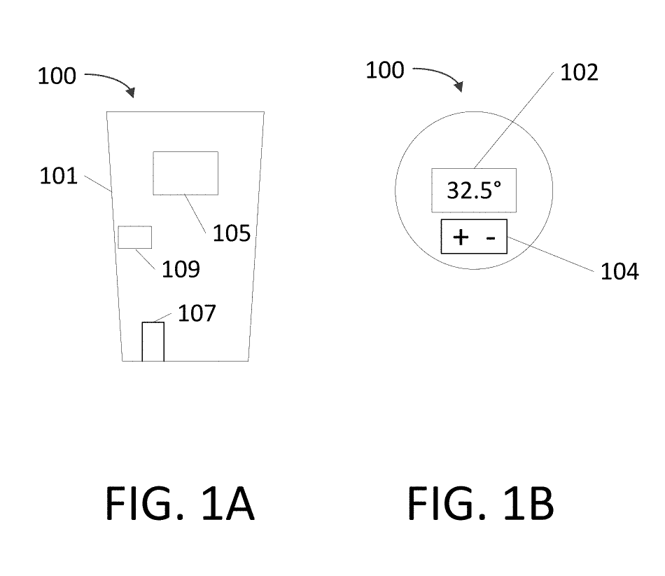

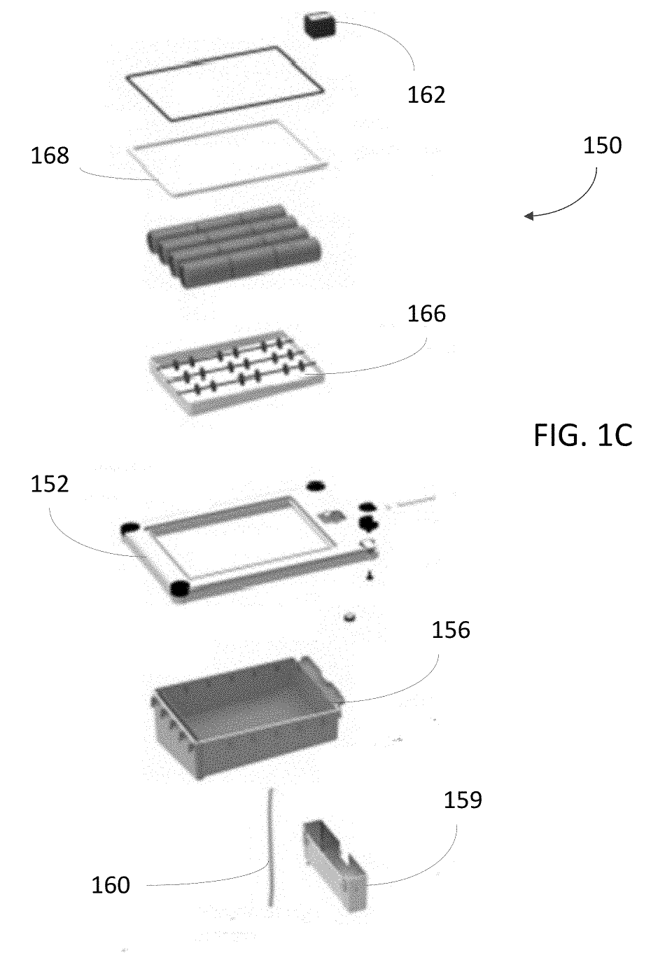

FIG. 1A illustrates a cross-sectional view of an illustrative probe 100 in accordance with the present disclosure. Probe 100 includes a first body 101 configured and arranged to be inserted in an opening of a beverage container, such as a wine bottle. First body 101 can be shaped like a stopper, and if desired can include a taper that allows a portion of probe 100 to be positioned within the container while the rest of probe 100 is external to the container. The taper can follow any contour and be on a portion of first body 101 such that only a part of first body 101 is tapered. The interference fit of probe 100 with the container (not shown in FIG. 1A) can prevent a fluid (e.g., a beverage) in the container from flowing through the opening. Probe 100 includes a temperature sensor 107 to measure the temperature of the beverage in the container. As shown in FIG. 1A, temperature sensor 107 can measure the temperature indirectly (e.g., without contacting the beverage). For example, probe 100 can include an infrared temperature sensor that is not submerged in the beverage. Although not shown in FIG. 1A, temperature sensor 107 can extend from probe 100 to measure the temperature of the beverage via direct conduction. For example, a thermocouple or an enclosed infrared temperature sensor can be coupled to probe 100 and submerged in the beverage in the container. An enclosed infrared temperature sensor can include a window that abuts the beverage and through which the temperature of the beverage is measured. Probe 100 includes a communication circuit 105 that wirelessly communicates with an external electronic device. Communication circuit 105 includes an antenna or other circuitry to communicate via one or more communication protocols, such as Bluetooth® (IEEE 802.15.1). In at least one embodiment, the external electronic device is a mobile device (e.g., a smart phone or tablet), or may be a quench container system that actively cools beverage containers disposed therein as described in U.S. patent application Ser. No. 15/800,709 filed on Nov. 1, 2017. In response to temperature sensor 107 detecting that the temperature of the beverage is at, below, or above a particular temperature, communication circuit 105 can trigger a notification on the mobile device that the temperature of the beverage is at, below, or above a particular temperature. The mobile device can be running an application that allows a user to set the particular temperature. The application can trigger an alarm on the mobile device that alerts the user that the temperature of the beverage is at, below, or above a particular temperature. While the embodiment of U.S. patent application Ser. No. 15/800,709 is used as a particular example, it will be appreciated by those of skill in the art that any cooling system, such as a refrigerator and the like, may be used instead.

Communication circuit 105 can cause an operation of the external electronic to be deactivated in response to the temperature sensor detecting that the temperature of the beverage is at, below, or above a particular temperature.

In at least one embodiment, the external electronic device can be a cooling device, such as the modular retrofit device described in U.S. patent application Ser. No. 15/800,709 filed on Nov. 1, 2017, which is herein incorporated by reference in its entirety for any purpose whatsoever. An illustrative embodiment of that device is also presented herein in FIG. 1C.

Referring to the exploded view of FIG. 1C, the modular quench unit 150 includes a main housing basin 156 used to hold beverages to be cooled or quenched. The quench unit 150 can include a top platform 152 that can be provided with mounts to help hold the unit 150 in place inside a cooler or other container. In some embodiments, the housing basin is dimensioned so as to hold twelve (12) standard aluminum cans or eight (8) longneck bottles, but those of skill in the art will appreciate that this can vary. The quench unit 150 also includes a housing 159 that includes a pump and associated electronics, including control electronics and communications circuitry (e.g., using WiFi or Bluetooth communication protocols that can communicate with device 100 and/or a smartphone device or other control device) that may be removable or modular that is situated adjacent to the basin 156. The pump is coupled to and receives cooled water from the cooler in which the quench unit 150 is mounted via an inlet hose 160. The cooler in which the quench unit 150 is adapted to be fitted may include a cooling (energy) source (e.g., a refrigeration coil) and/or simply an ice-water bath. The modular quench unit 150 is designed to take advantage of the existing source of cooled water by locating the hose 160 at or near the bottom of the ice water bath in the cooler and drawing the cooled water through the hose by means of the pump into the basin 156 and the beverages contained therein. In some embodiments, the hose 160 may include a filter or screen to keep out small ice particles and debris and one or more extensions that extend outwardly into the cooling bath to ensure an adequate cooling fluid flow. If desired, a lighted bezel 168 can also be provided that can act as an indicator light to indicate when a desired temperature has been reached, or for other reasons such as providing illumination and the like.

Power for the pump is preferably provided by a (preferably rechargeable lithium ion) battery 162 which may be included in the quench unit 150 within the housing 159. An external charging dock or charger (not shown) can be provided with the system. The battery can be removable. The pump preferably directs water into the basin 156 in a manner similar to a water fall from a first end proximate to the pump to a second end which can include a weir plate that allows the cooled water above a fixed height level to drain back into the cooler via gravity after passing over and/or through the beverage containers. If desired, the weir may include orifices or slots to further promote rapid water flow through the weir and drainage to enhance water currents alongside the beverage containers. The basin 156 may also contain a removable roller wheel assembly 166 or other beverage container drive system (such as fluid jets) which may by action of the rolling wheels, cause the beverages to rotate around their longitudinal axes to enhance removal of heat from the beverage containers. The wheel assembly 166 may mechanically couple to a drive port that is connected to an electric motor within the housing 159.

In cooperative systematic operation between embodiments 100 and 150, for example (or other cooling device) communication circuit 105 can cause a pump of the cooling device (that circulates a cooling fluid) and/or a motor (associated with the cooling device that rotates the container), to be deactivated in response to the temperature sensor detecting that the temperature of the beverage in the container is at, below, or above the particular temperature. That is, probe 100 can be inserted in a container that is positioned in the cooling device. Probe 100 and cooling device can work cooperatively to quench a beverage to a particular temperature.

FIG. 1B illustrates a top view of an illustrative probe 100 in accordance with the present disclosure. Probe 100 can include a display (e.g., 102) for displaying the measured temperature and/or the particular temperature. Display 102 can be a liquid crystal display (LCD) and/or a light emitting diode (LED) display, for example. Probe 100 can include an interface 104 (e.g., buttons) for setting the particular temperature. As shown in FIG. 1B, a ‘+’ button can increment the particular temperature by a degree, or a fraction thereof, and a ‘−’ button can decrement the particular temperature by a degree, or a fraction thereof. Display 102 can display the particular temperature to aid in selecting the particular temperature. Although not shown in FIG. 1B, display 102 can be or include a ring of LEDs to indicate the measured temperature of the beverage and/or if the temperature of the beverage is at, below, or above the particular temperature. The ring of LEDS can be positioned at or near the circumference of probe 100. Although FIG. 1B shows the top of probe 100 being circular, embodiments are not so limited. For example, the top of probe 100 can have any polygonal shape and the lower portion of first body 101 can be substantially circular to fit in the opening of a beverage container.

Probe 100 includes a power source 109 that supplies power to display 102, communication circuit 105, and temperature sensor 107. Power source 109 can be a battery, and/or can use a piezoelectric element that generates power when the probe is moved, such as via rotation. Probe 100 can include a compartment and associated electrical conductors configured and arranged to receive a battery. Although not shown in FIG. 1A, power source 109 can include one or more photovoltaic cells positioned at a top surface of probe 100.

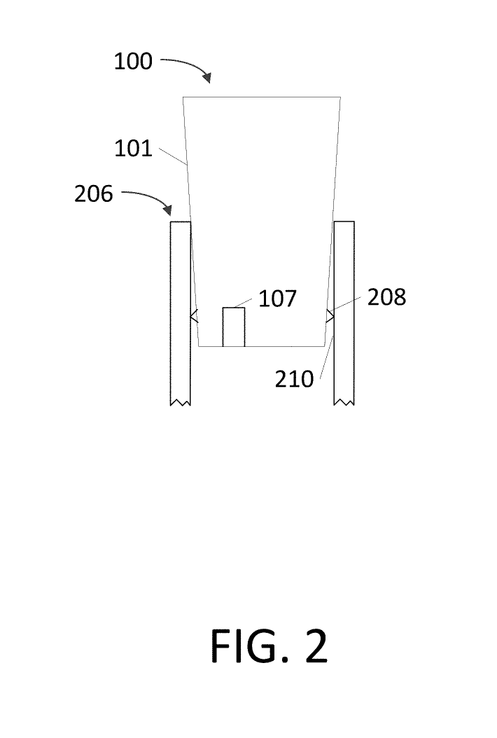

FIG. 2 illustrates a cross-sectional view of an illustrative probe 100 in accordance with the present disclosure. In FIG. 2, probe 100 is inserted in an opening of a beverage container 206. First body 101 allows a portion of probe 100 to be positioned within container 206 while the rest of probe 100 is external to container 206. In at least one embodiment, first body 101 includes a sealing mechanism 208 to further prevent the beverage from flowing through the opening. Sealing mechanism 208 can include one or more sealing rings that cooperate (e.g., form an interference fit) with an inner surface 210 of container 206. Although not shown in FIG. 2, a lever can be coupled to sealing mechanism 208; for example, to engage the sealing rings. Sealing mechanism 208 can include a vacuum seal.

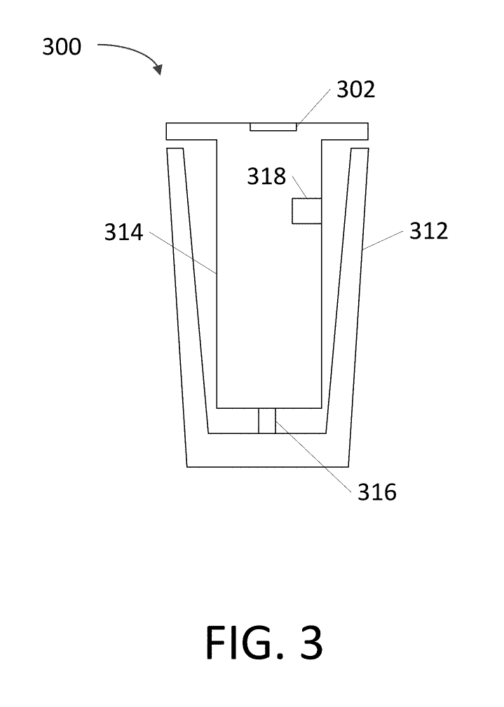

FIG. 3 illustrates a cross-sectional view of an illustrative probe 300 in accordance with the present disclosure. In FIG. 3, probe 300 includes a second body 314 and a first body 312. Second body 314 can include a counterweight 318, a communication circuit (not shown), a temperature sensor (not shown), a display 302, and a power source (not shown). Second body 314 is coupled to first body 312 via a bearing 316 (e.g., a floating bearing). Counterweight 318 maintains an orientation of second body 314 while first body 312 rotates about second body 314. For example, counterweight 318 can maintain a substantially horizontal orientation of display 302 while the container in which probe 300 is inserted is rotated. As the container is rotated, first body 314 rotates with the container, but counterweight 318 and bearing 316 cooperate to maintain the substantially horizontal orientation of display 302 (which can be analogous to display 102 illustrated in FIG. 1B) so that display 302 can still be read under direct visual observation.

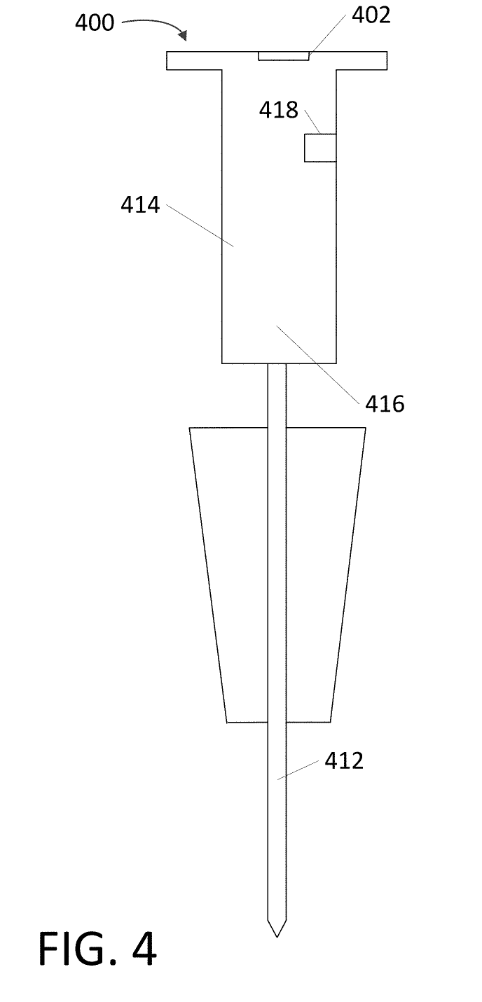

In a further embodiment, as show in FIG. 4, instead of a stopper, the first body is an elongate slender probe that may be rigid with a narrowed distal tip that is configured to be pushed through a native stopper made for example of cork, foam, or the like. The slender probe can be a hollow plastic or metallic member housing, for example, leads to a thermocouple disposed on the distal tip of the first body, or at a location proximal to the distal tip.

For purposes of illustration, FIG. 4 depicts a cross-sectional view of an illustrative probe 400 in accordance with the present disclosure. None of FIGS. 1A-4 are meant to show dimensions or clearances. In FIG. 4, probe 400 includes a second body 414 and a first body 412. Second body 414 can include a counterweight 418, a communication circuit (not shown), a temperature sensor (not shown), a display 402, and a power source (not shown). Second body 414 is coupled to first body 412 via a bearing 416 (e.g., a floating bearing, disposed within 414). Counterweight 418 maintains an orientation of second body 414 while first body 412 rotates with respect to second body 414. For example, counterweight 418 can maintain a substantially horizontal orientation of display 402 while the container in which probe 400 is inserted is rotated. As the container is rotated, first body 414 rotates with the container, but counterweight 418 and bearing 416 cooperate to maintain the substantially horizontal orientation of display 402 (which can be analogous to display 102 illustrated in FIG. 1B) so that display 402 can still be read under direct visual observation. It will be appreciated that a one piece design of the embodiment of FIG. 3 or 4 can be pursued not including a bearing, particularly where no display is present.

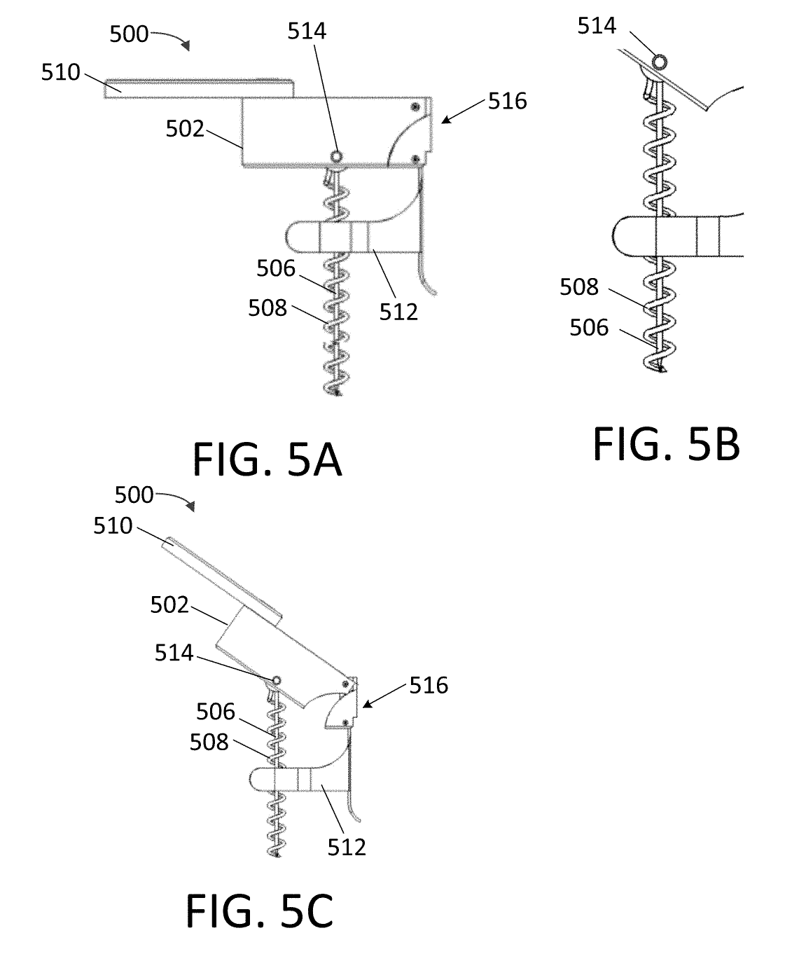

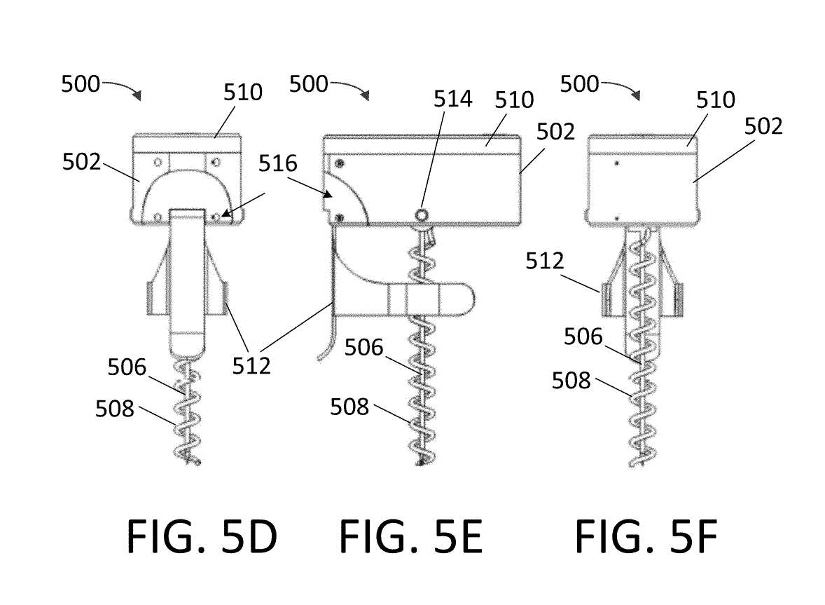

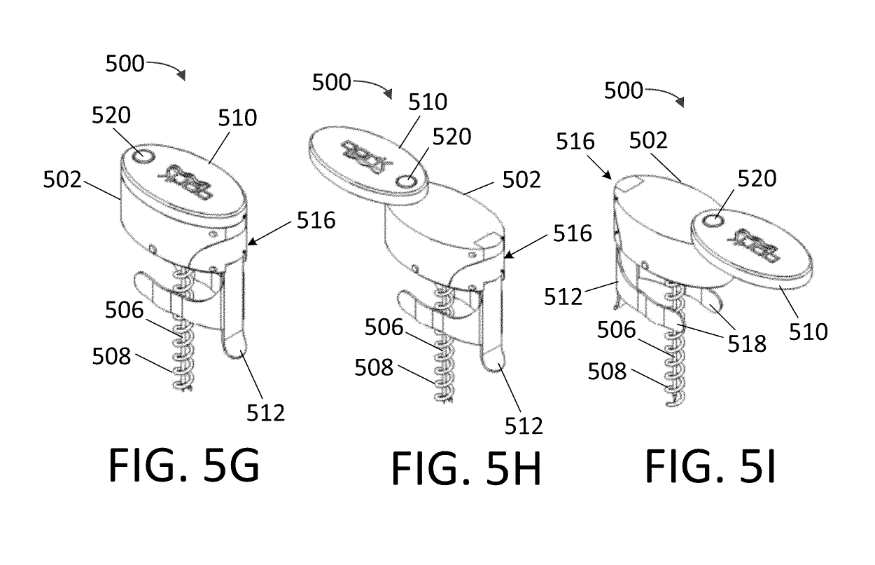

FIG. 5A illustrates a side view of an illustrative bottle opener 500 in accordance with the present disclosure. FIG. 5B illustrates a zoomed-in view of the bottle opener 500. FIG. 5C illustrates a side view of the bottle opener 500. FIGS. 5D-5F illustrate a back view, a side view, and a front view of the bottle opener 500, respectively. FIGS. 5G-5I illustrate isometric views of the bottle opener 500.

As shown in FIG. 5A, the bottle opener 500 includes a body 502. The body 502 includes a temperature sensor 506 to measure the temperature of the beverage in the bottle. The bottle opener 500 includes a temperature sensor 506 (e.g., a thermocouple) that extends from body 502 to measure the temperature of the beverage via direct conduction. The body 502 includes a temperature sensing circuit (not shown) and a power source (not shown). The temperature sensing circuit is coupled to temperature sensor 506 and the power source. As shown in FIG. 5B, temperature sensor 506 can be shaped as a needle to facilitate passage of temperature sensor 506 through a stopper (e.g., a cork) in the bottle.

Body 502 includes a communication circuit (not shown) that wirelessly communicates with an external electronic device. The communication circuit includes an antenna or other circuitry to communicate via one or more communication protocols, such as Bluetooth® (IEEE 802.15.1). In at least one embodiment, the external electronic device is a mobile device (e.g., a smart phone or tablet), or may be a quench container system that actively cools beverage containers disposed therein as described in U.S. patent application Ser. No. 15/800,709 filed on Nov. 1, 2017. In response to temperature sensor 506 detecting that the temperature of the beverage is at, below, or above a particular temperature, the communication circuit can trigger a notification on the mobile device that the temperature of the beverage is at, below, or above a particular temperature. The mobile device can be running an application that allows a user to set the particular temperature. The application can trigger an alarm on the mobile device that alerts the user that the temperature of the beverage is at, below, or above a particular temperature.

The communication circuit can cause an operation of the external electronic to be deactivated in response to the temperature sensor detecting that the temperature of the beverage is at, below, or above a particular temperature. This can be caused directly or indirectly. For example, in one embodiment, the communication circuit periodically sends temperature data to the external electronic (e.g., every 0.5 seconds, every second, etc.). Upon the attainment of a particular temperature, the external electronic (e.g., smart phone, cooling unit, etc.) can send a signal back to the communication circuit to cause the device (e.g., 100, 300, 400, 500) to activate an indicator, such as a LED light, or sound emitter, indicating that a desired temperature has been reached by the contents of the beverage container.

In at least one embodiment, the external electronic device can be a cooling device, such as the modular retrofit device described in U.S. patent application No. 15/800,709 filed on Nov. 1, 2017, which is herein incorporated by reference in its entirety for any purpose whatsoever. For example, the communication circuit can cause a pump of the cooling device (that circulates a cooling fluid) and/or a motor (associated with the cooling device that rotates the container), to be deactivated in response to the temperature sensor detecting that the temperature of the beverage in the container is at, below, or above the particular temperature. That is, bottle opener 500 can be inserted in a bottle that is positioned in the cooling device. Bottle opener 500 and cooling device can work cooperatively to quench a beverage to a particular temperature.

Although not specifically shown, bottle opener 500 can include a display on body 502 for displaying the measured temperature and/or the particular temperature. The display can be a liquid crystal display (LCD) and/or a light emitting diode (LED) display, for example. Although not specifically shown, bottle opener 500 can include an interface (e.g., buttons) on body 502 for setting the particular temperature. For example, the body 502 can include a ‘+’ button to increment the particular temperature by a degree, or a fraction thereof, and a ‘−’ button to decrement the particular temperature by a degree, or a fraction thereof. The display can display the particular temperature to aid in selecting the particular temperature. The display can be, or include, a ring of LEDs to indicate that the measured temperature of the beverage and/or if the temperature of the beverage is at, below, or above the particular temperature.

Body 502 includes a power source that supplies power to the communication circuit and temperature sensor 506, and the display. The power source can be a battery, and/or can use a piezoelectric element that generates power when the probe is moved, such as via rotation (e.g., from engaging and passing corkscrew 508 through a stopper). Body 502 can include a compartment and associated electrical conductors configured and arranged to receive a battery. The power source can include one or more photovoltaic cells positioned on a surface of body 502.

A corkscrew 508 is coupled to body 502. The temperature sensor 506 is positioned within the windings of corkscrew 508. Temperature sensor 506 and corkscrew 508 have a common central axis so that turning the bottle opener 500 to engage and pass the corkscrew 508 through a stopper (e.g., a cork) does not put undue and/or excessive stress on temperature sensor 506. Temperature sensor 506 is long enough to pass through a stopper completely and contact the beverage in the bottle. The length of temperature sensor 506 can be longer than the length of corkscrew 508 so that the temperature sensor 506 contacts the beverage in the bottle even if the corkscrew 508 does not pass completely through the stopper in the bottle. Although FIGS. 5A-5I show corkscrew 508 and temperature as separate components, embodiments are not so limited. For example, corkscrew 508 can be the temperature sensor 506. However, corkscrew 508 has to be long enough to pass through the stopper completely so that corkscrew 508 contacts the beverage. In another embodiment, corkscrew 508 is hollow and includes a temperature sensor at the end of corkscrew 508. Wire(s) from the temperature sensor to the body 502 (e.g., for power and/or displaying the measured temperature) can be passed through the hollow of corkscrew 508. Corkscrew 508 and temperature sensor 506 can be hingedly coupled to body 502 (e.g., via hinge 514) so that corkscrew 508 and temperature sensor 506 can be positioned near or against body 502 for storage and/or transport of bottle opener 500.

At least one embodiment includes retainer or lock 512 hingedly coupled (e.g., via hinge 516) to body 502. Extension member 510 can be made of stainless steel; however, embodiments are not so limited. Retainer 512 can be a compliant mechanism including a pair of arms 518 (shown in FIG. 5I, for example). The spacing of the arms 518 can be less than a diameter of a typical neck of a bottle. For example, the spacing of arms 518 can be 1.1 inches. When a neck of a bottle is inserted between arms 518, the displacement of the arms 518 away from one another caused by the neck of the bottle generates a force that holds the neck of the bottle in place between the arms 518. After corkscrew 508 has been inserted in a stopper (e.g., a cork) of a bottle, retainer 512 can be rotated about a hinge (e.g., 516) so that arms 518 engage the neck of the bottle. As shown by FIGS. 5A and 5C, once the neck of the bottle is secured in between arms 518, body 502 can be rotated about hinge 516 to facilitate removing the stopper from the bottle. The cork screw 508 and temperature sensor 506 are raised relative to the retainer 512. Retainer 512 can be hingedly coupled to body 502 (e.g., via hinge 516) so that retainer 512 can be positioned near or against body 502 for storage and/or transport of bottle opener 500.

At least one embodiment includes an extension member 510 rotatably coupled to body 502 (e.g., via hinge 520). Extension member 510 can be made of an aluminum material (e.g., anodized aluminum); however, embodiments are not so limited. As shown by FIG. 5G, for example, in a first orientation, extension member 510 is positioned on top of body 502. Extension member 510 can have a substantially similar shape and/or profile as body 502 so that when in the first orientation, extension member 510 appears to be part of body 502. Extension member 510 can be in the first orientation for storage and/or transport of bottle opener 500. As shown in FIGS. 5H and 5I, for example, in a second orientation, extension member 510 is rotated (e.g., about hinge 520) approximately 180 degrees away from the first orientation. When in the second orientation, extension member 510 can serve as an extended handle of bottle opener 500 to increase the mechanical advantage of bottle opener 500. Advantageously, the extension member 510 increases the mechanical advantage in the second orientation while maintaining a smaller size of bottle opener 500 orientation for storage and/or transport in the first orientation.

In at least one embodiment, the bottle opener 500 has the following dimensions. The width of the body 502 can be 1.5 inches, the height of the body 502 (including extension 510) can be 1.26 inches, and the length of the body 502 can be 2.75 inches. The height of the bottle opener 500 with temperature sensor 506 and cork screw 508 extended, as shown in FIG. 5A, for example, can be 4.5 inches.

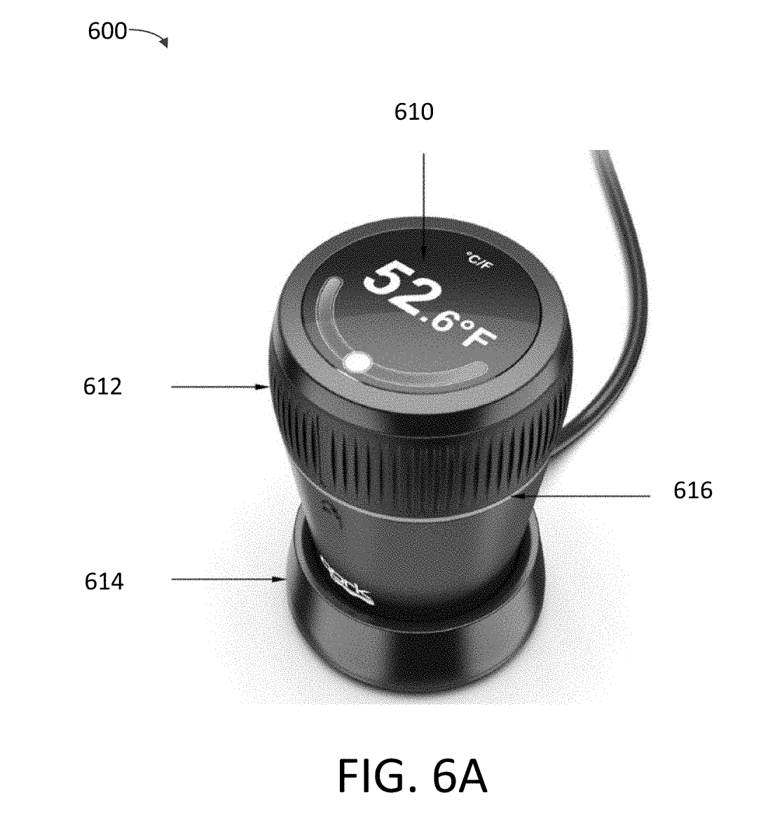

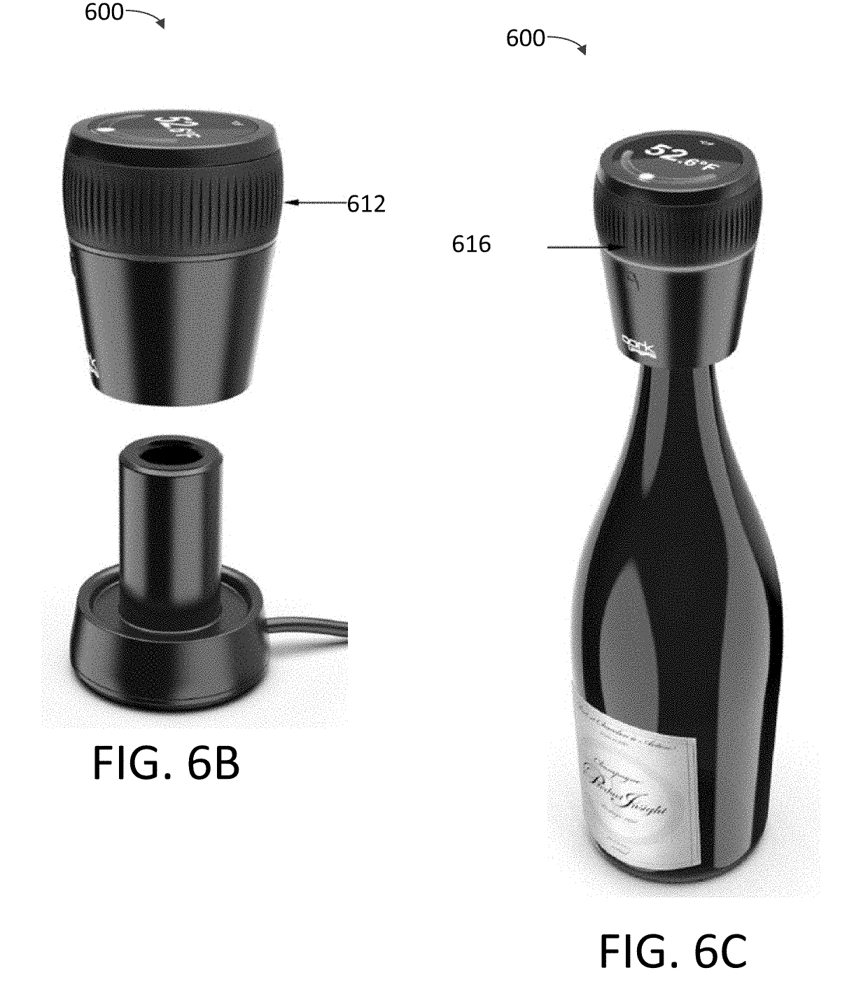

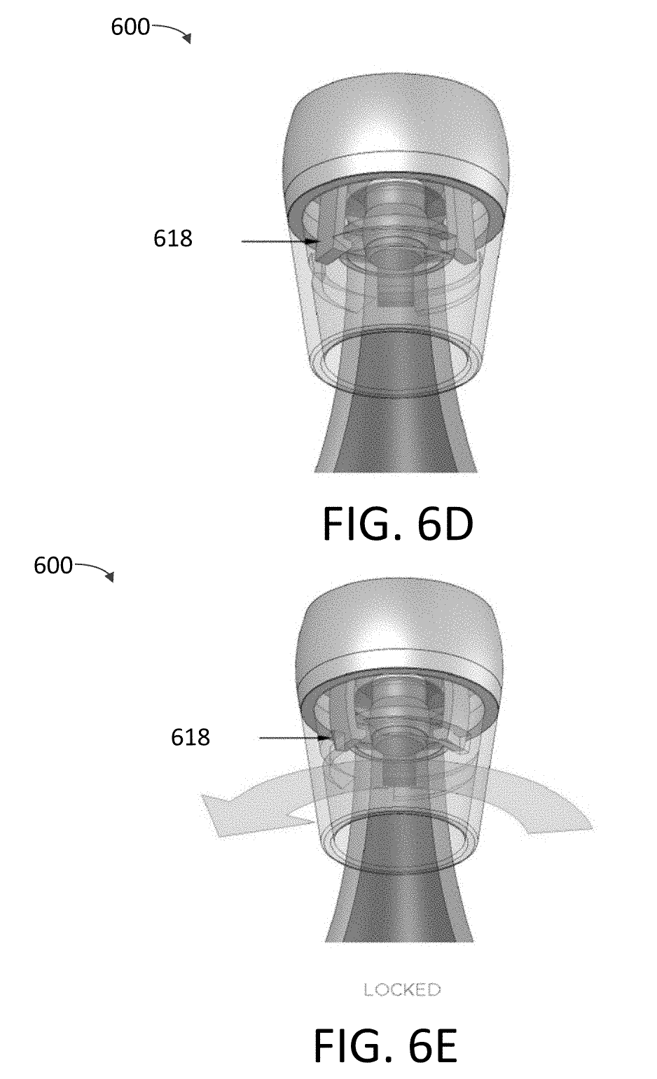

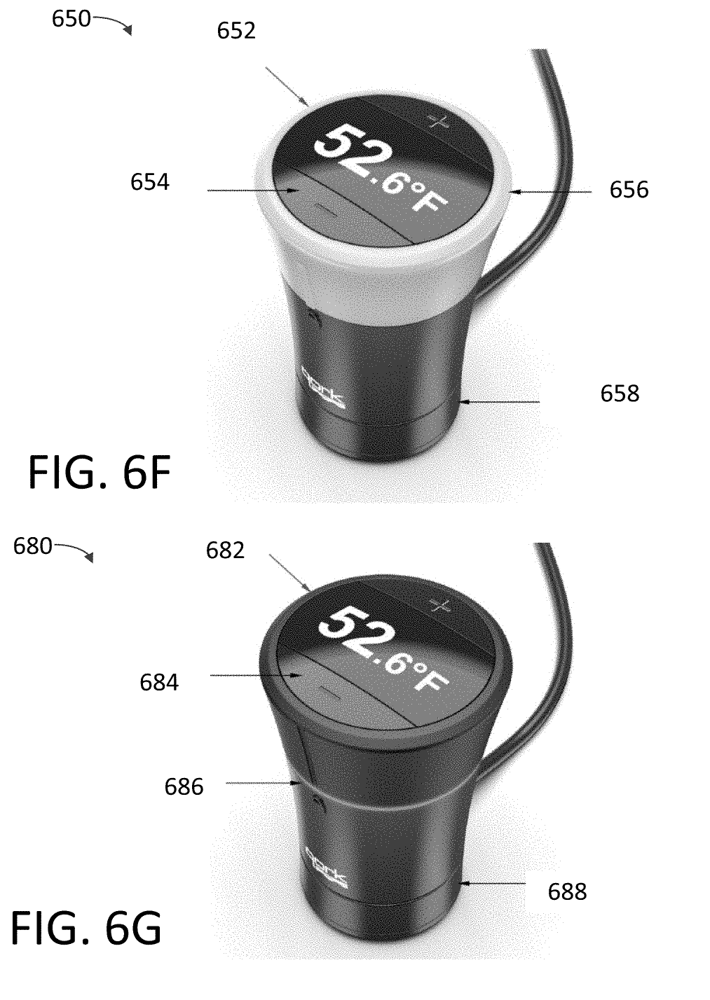

In further accordance with the disclosure, FIGS. 6A-6E present a further embodiment 600 of a probe in accordance with the present disclosure. Embodiment 600 can use any desired methods and hardware to measure temperature of the contents of a container directly and/or indirectly. Embodiment 600 includes a probe that is configured to be removably fastened to a container using any desired technique. As illustrated, and as shown in FIGS. 6D-6E, embodiment 600 can include a lock for holding the probe tight to the container, such as a pressurize bottle, wherein the lock uses displaceable or articulable arms, 618 having radially-inwardly pointed protrusions or tines at their lower end that capture threads and/or a flange of a bottle. For example, arms 618 can be integrally formed with the body of embodiment 600 or a portion thereof at an upper end and be biased radially outwardly, for example, as a result of molding. The lower ends of the arms 618 can then be biased radially inwardly for example, by rotating an upper portion of the probe 600 (e.g., textured grip 612) with respect to a lower portion of the probe 600. Cammed or ramped surfaces (not shown) can be provided inside of probe 600 that are coupled to grip 612 can be rotated into contact with the arms 618 to cause them to clamp down on the bottle threads or flange. If desired, an indicator light, such as an illuminated indicator ring 616 can be provided, wherein rotating the grip 612 to move the arms inward to grip the bottle can also complete an electrical circuit that causes the indicator light to illuminate. Preferably, embodiment 600 is powered by a rechargeable battery that can be charged, for example, by placing the probe on a charging base 614. Charging base 614 preferably has suitable circuitry to step down AC power from a source (e.g., wall socket) and invert it to create a DC charging signal for the battery of the probe 600.

Probe 600 can further include a display 610, such as a touch screen, or a digital readout that it coupled to circuitry within embodiment 600 that is configured and arranged to process a temperature detection signal of the contents of a beverage and display it on the probe 600. One or more of any temperature detection techniques can be used (direct contact probe, infrared beam, and the like) to detect the temperature of the contents of the container. As illustrated, the display 610 is provided in the form of a sealed touch screen display and I/O device that can display the temperature measured by the probe numerically and/or graphically. As an I/O device, the display 610 can be used to program the probe or view different menus or data displays. Probe 600 can include any of the features described elsewhere herein with respect to the other disclosed probes.

FIG. 6F presents an alternative embodiment 650 of a probe that is configured the same as the embodiment of FIGS. 6A-6E with certain differences. For example, a non-touchscreen display 652 is provided that can display the temperature or other parameters (e.g., time of day, elapsed time during cooling, cooling rate, and the like) and includes one or more sealed buttons 654 for setting a desired target temperature, and the like. An indicator light 656 can similarly be provided that can illuminate, for example, when the probe 650 is locked onto a bottle, and/or when a target temperature has been reached. The indicator light 650 can include an annular lens made from polymeric material such as silicone that illuminates around its periphery when activated. In the illustrated embodiment, the area of illumination includes the entire lightly colored grip portion. As with the preceding embodiment, the probe 650 can be placed on a charging base 658 to charge its onboard battery. FIG. 6G presents a variation 680 of the embodiment of FIG. 6F that includes an illuminated indicator ring similar to the embodiment of FIGS. 6A-6E. Probes 650, 680 can include any of the features described elsewhere herein with respect to the other disclosed probes.

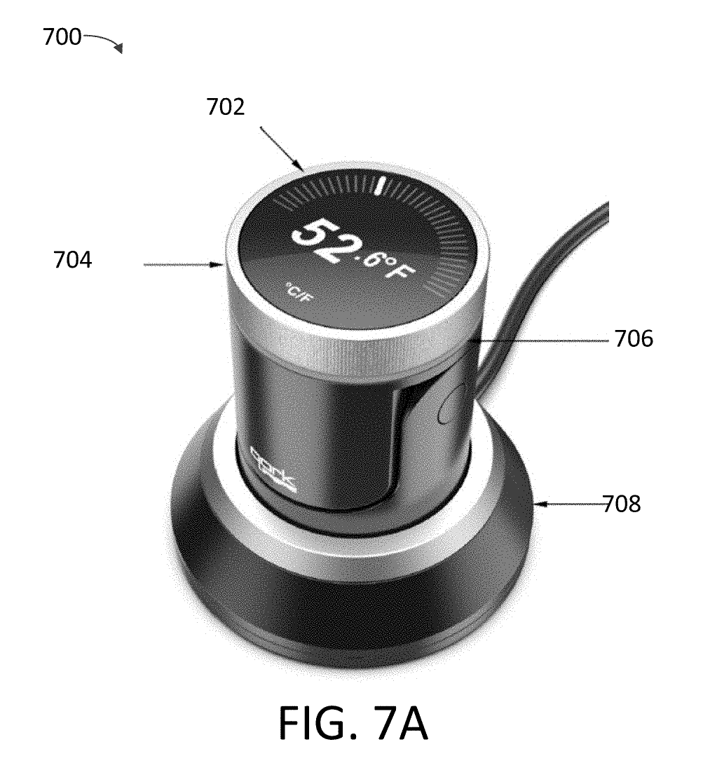

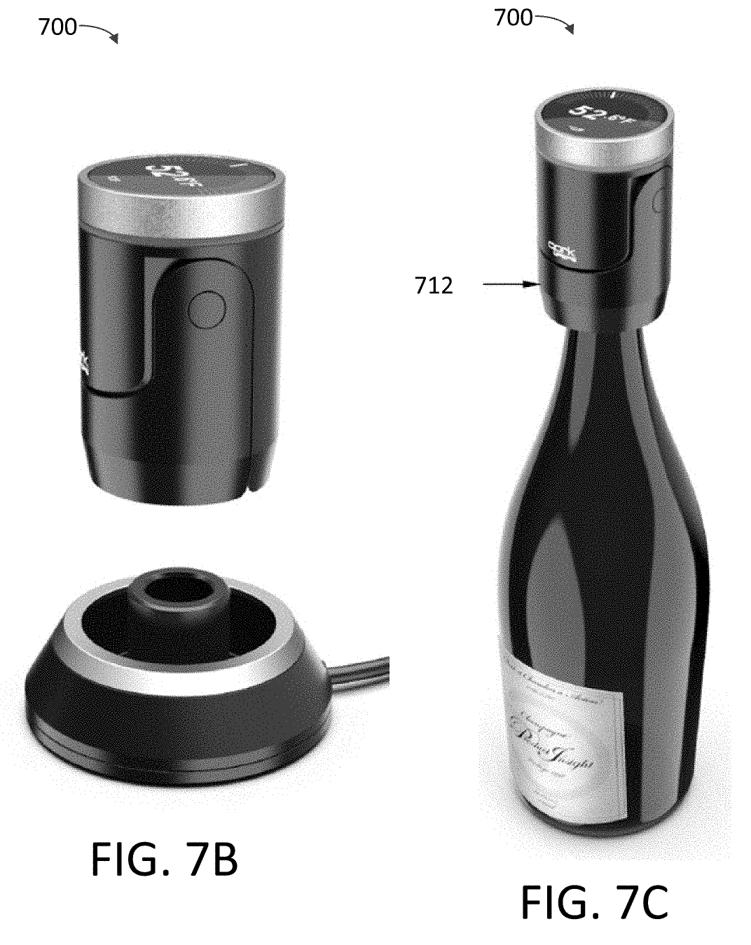

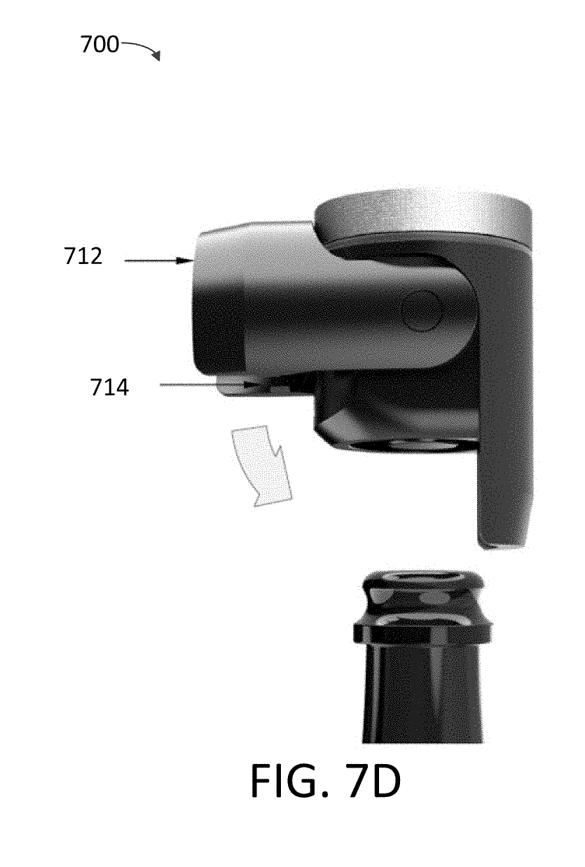

FIG. 7 presents a further embodiment 700 of a probe that includes a display 702 on its upper surface and a rotatable manual control ring 704 that can be used to set a target temperature to be measured by the probe 700. An illuminated (e.g. LED) indicator ring 706 can be provided for when the probe 700 is locked onto a container and/or when the contents of a container reach a desired temperature. Probe 700 can similarly be charged on a charging base, and include any functionality disclosed for probes disclosed elsewhere herein. Probe 700 latches onto a container using a different structure from the preceding embodiment. Specifically, and with respect to FIG. 7D, a lock is provided that includes an articulating lever 712 is swing down about a pivot in the probe 700 having one or more tines, bosses or flanges 714 that slide under a flange of the bottle or container to which it attaches to lock the probe 700 to the container or bottle. Probe 700 can include any of the features described elsewhere herein with respect to the other disclosed probes.

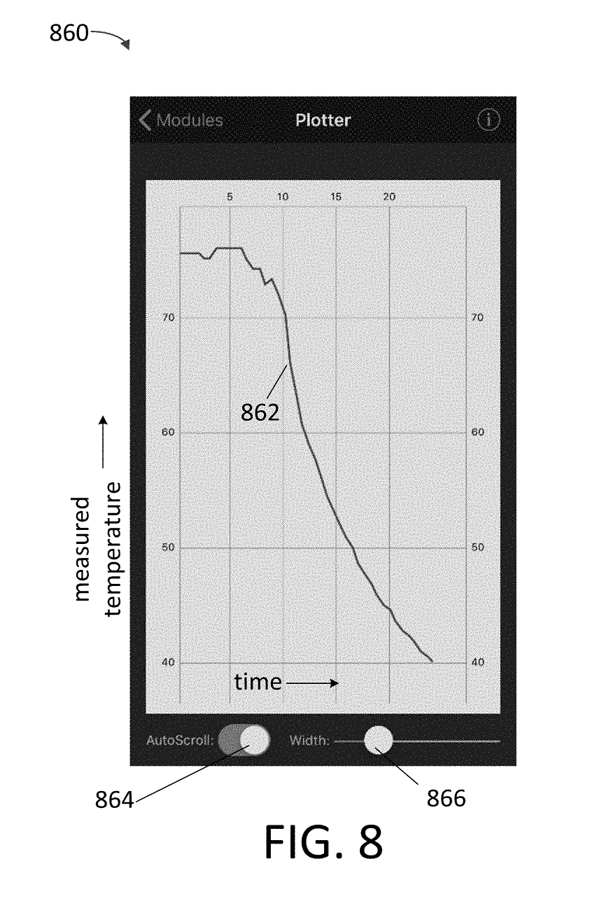

FIG. 8 illustrates an illustrative user interface 860 of an external device displaying a measured temperature 862 of a beverage in accordance with the present disclosure. As explained above, embodiments of the disclosed probe (e.g., 100, 300, 400) described in association with FIGS. 1-4 and embodiments of the disclosed bottle opener (e.g., 500) described in association with FIGS. 5A-5I can communicate (e.g., via a communication circuit) with an external device (e.g., a mobile device). The mobile device can run an application that allows a user to monitor the measured temperature 862 of the beverage in the container or bottle. For example, as shown in FIG. 8, the application can include user interface 860 that displays the measured temperature 862 over time in graphical form. User interface 860 can include a toggle switch 864 for automatically scrolling (AutoScroll) the graph as time passes. User interface 860 can include a slider 866 to change the range of time (width) displayed on the graph.

In order to address various issues and advance the art, the entirety of this application (including the Cover Page, Title, Headings, Field, Background, Summary, Brief Description of the Drawings, Detailed Description, Claims, Abstract, Figures, and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all disclosed embodiments. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is illustrative and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a BQ™ individual and/or enterprise user, database configuration and/or relational model, data type, data transmission and/or network framework, syntax structure, and/or the like, various embodiments of the BQ™ may be implemented that enable a great deal of flexibility and customization.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

The methods and systems of the present disclosure, as described above and shown in the drawings, among other things, provide for improved beverage cooling methods, systems and machine readable programs for carrying out the same. It will be apparent to those skilled in the art that various modifications and variations can be made in the devices and methods of the present disclosure without departing from the spirit or scope of the disclosure. Thus, it is intended that the present disclosure include modifications and variations that are within the scope of the subject disclosure and equivalents.

What is claimed is:

1. A probe configured to be received in an opening of a beverage container, comprising:
a stopper configured and arranged to fit at least partially through the opening of the beverage container after a native stopper has been removed from the beverage container, the stopper being configured and arranged to prevent a liquid in the container from flowing through the opening of the beverage container;
a communication circuit configured and arranged to wirelessly communicate with an external electronic device;
a temperature sensor circuit configured and arranged to measure a temperature of the beverage container; and
a power source configured and arranged to supply power to the communication circuit.

2. The probe of claim 1, further comprising a display configured and arranged to display the measured temperature.

3. The probe of claim 2, further comprising:
a housing in which the display is disposed, wherein the housing is rotatably coupled to the stopper via a bearing; and
a counterweight configured and arranged to maintain a relative stationary orientation of the housing while the housing rotates with respect to the stopper.

4. The probe of claim 1, wherein the communication circuit is configured and arranged to send a signal to the external electronic device in response to the temperature sensor circuit measuring a predetermined temperature.

5. The probe of claim 1, wherein the communication circuit is configured and arranged to trigger deactivation of an operation of the external electronic device.

6. The probe of claim 1, further comprising a lever that engages an articulable seal to prevent the liquid in the beverage container from flowing through the opening.

7. The probe of claim 1, wherein the temperature sensor circuit is configured to measure the temperature of the liquid by way of direct physical contact.

8. An apparatus, comprising:
a housing;
a temperature sensor circuit coupled to the housing and configured to measure a temperature of a liquid in a bottle;
a corkscrew coupled to the housing and configured to remove a stopper from the bottle;
a communication circuit configured to wirelessly communicate with an external electronic device; and
a power circuit configured to supply power to the communication circuit and the temperature sensor circuit.

9. The apparatus of claim 8, wherein the temperature sensor circuit is configured to measure the temperature of the liquid while a stopper is in the bottle.

10. The apparatus of claim 8, wherein the temperature sensor circuit is configured to measure the temperature of the liquid while the corkscrew engages the stopper in the bottle.

11. The apparatus of claim 8, wherein the temperature sensor circuit is integral with the corkscrew.

12. The apparatus of claim 8, wherein:
the corkscrew is hollow;
the temperature sensor circuit is coupled to an end of the corkscrew; and
a connection between the temperature sensor circuit and the power circuit that passes through the corkscrew.

13. The apparatus of claim 8, further comprising a retainer hingedly coupled to the housing configured to:
receive a neck of the bottle; and
secure the neck of the bottle.

14. A device to be received in an opening of a beverage container, comprising:
a probe configured to fit at least partially through the opening of the beverage container;
a communication circuit configured to wirelessly communicate with an external electronic device;
a temperature sensor circuit configured to measure a temperature of the beverage container;
a power circuit configured to supply power to the communication circuit; and
a lock including at least one displaceable arm to lock the probe to the beverage container, the lock being adjustable from a first unlocked condition, wherein the at least one displaceable arm is disengaged from the beverage container and the device can be removed from the beverage container, to a second, locked condition, wherein the at least one displaceable arm is engaged with the beverage container.

15. The device of claim 14, wherein the lock engages a radially outwardly extending flange of the beverage container.

16. The device of claim 14, wherein the lock engages a radially inwardly facing surface of the beverage container.

17. The device of claim 14, wherein the lock engages includes an inner surface of the beverage container.

18. The device of claim 14, wherein the lock engages a bottom of the beverage container.

19. The device of claim 18, wherein the lock engages a ridge or boss on a bottom of the beverage container.

20. The device of claim 18, wherein the lock engages an indentation formed on a bottom of the beverage container.
